(19) United States
(12) Patent Application Publication
(10) Pub. No.: US 2017/0129133 A1
(43) Pub. Date: May 11, 2017

(54) Machine to Build Structures

(71) Applicant: Edgar Bolivar, Clovis, NM (US)

(72) Inventor: Edgar Bolivar, Clovis, NM (US)

(21) Appl. No.: 14/933,880

(22) Filed: Nov. 5, 2015

(51) Int. Cl. B28B 1/00

(52) U.S. Cl. CPC B28B 1/00

(57) ABSTRACT

Disclosed is a machine meant to build structures capable of moving over a surface, having unlimited range, for the purpose of doing tasks involved in the manufacturing of a structure or building: from laying the correct building material, painting, running electrical, installing plumbing, fixtures, doors and windows, carve on surfaces already printed, smooth out built surfaces, or remove the correct amount of material needed to gain the desired effect in a designed product. Meaning that by the time leaves the build area, it is literally ready to move in. The machine to build structures can produce at lower cost, can build with improved quality, at a higher rate of speed than was heretofore possible, with significantly reduced exposure to safety, costs and health hazards associated with this kind of construction activities in the past.

### STATEMENT REGARDING FEDERALLY SPONSORED R&D

None.

### BACKGROUND OF THE INVENTION

1. Field of the invention

The present invention relates to a machine which is able to 3d print and manufacture structures, using various types of materials and methods.

2. Description of the Prior Art

Traditional construction methods involves enormous amounts of human labor, skyrocketing total costs, making the product unavailable to a majority market.

Wasted materials are common and to be expected during construction, 15% of materials that went into production are wasted on average, increasing costs unnecessarily.

Weather delays, material damage due exposure to weather. Often dangerous situations such as high altitude brick laying. Then a strict schedule has to be followed where; wiring for example, cannot be done until walls are piece built.

Prefab, even 3d printed prefab commonly requires crane and heavy truck access, especially for multi-story, not to mention the high cost related to the transport and installation of these structures, plus even with current advances in technology and construction, human labor is still needed in order to finish out the structure and prepare it for dwellers.

Average construction time of a house, if built by a contractor is 8 to 11 months just to finish an ordinary sized home.

Construction sites are normally very dangerous places and construction work is recognized as an accident prone occupation.

New Paradigms in Construction:

Currently, the size of an object 3d printed is limited to the size of the printer. Printing times tend to be slow, and therefore limiting the production capabilities for the machines.

United States Patent Application 20090038258 of Pivac, issued on Feb. 12, 2009 for AUTOMATED BRICK LAYING SYSTEM FOR CONSTRUCTING A BUILDING FROM A PLURALITY OF BRICKS, discloses an automated brick laying system (10) for constructing a building from a plurality of bricks (16) comprises a robot (12) provided with a brick laying and adhesive applying head (18), a measuring system (13), and a controller (14) that provides control data to the robot (12) to lay the bricks (16) at predetermined locations. The measuring system (13) measures in real time the position of the head (18) and produces position data for the controller (14). The controller (14) produces control data on the basis of a comparison between the position data and a predetermined or pre-programmed position of the head (18) to lay a brick (16) at a predetermined position for the building under construction. The controller (14) can control the robot (12) to construct the building in a course by course manner where the bricks (16) are laid sequentially at their respective predetermined positions and where a complete course of bricks for the entire building is laid prior to laying of the brick for the next course.

This reference is deficient in that the machine described requires a raw material that is not readily available and that it requires work and energy to prepare, to get it into the form of a brick. Then that means that overall a house constructed of brick will be more expensive to build than a house made out of concrete or clay just taken right off the ground, the reference is also deficient in that the machine described is only capable of building the walls, which means that still quite a lot of human labor has to be involved in the development of structures while using this method for the construction of the walls.

United States Patent Application 20150292229 of Kollegger issued on, Oct. 15, 2015 for METHOD FOR PRODUCING A TOWER CONSTRUCTION FROM REINFORCED CONCRETE, discloses a method for producing a tower construction (1) from reinforced concrete having at least one cavity (35) that extends in the longitudinal direction within, wherein essentially initially there are arranged along a periphery (12) of the tower construction (1) double-wall elements (2), each comprising an external plate (3) as well as an internal plate (4) in vertical or inclined position, forming vertical external joints (5) as well as vertical internal joints (6) between the external plates (3) and the internal plates (4), wherein the double-wall elements (2) are secured against toppling over in their position arranged next to each other, wherein subsequently there is installed a reinforcement (9) in the area of the vertical external joints (5) in-between the external plates (3) as well as the vertical internal joints (6) in-between the internal plates (4), followed by the vertical external joints (5) and the vertical internal joints (6) in-between the double-wall elements (2) being suitably closed and the double-wall elements (2) being filled using filling concrete (23). This is repeated as often as necessary until a desired overall height of the tower construction (1) is obtained.

This reference is deficient in that the method of building the wall itself requires human labor. From the construction of the plates, panels and joints, to the pouring of the actual concrete, curing and texturing is meant to be done by hand. The wall building can be obtained by simply pouring a concrete or clay material in the same fashion as a 3d printer, the material can be printed with the controlled consistency needed, and just as thick as required. The imperfections can simply be removed or smoothed out later or even at the same time as it is being poured by the machine, with great accuracy and with almost no margin for error, simply change the tool, so instead of a 3d printing extruder for concrete or clay, a milling or trowel tool can be used to obtain the desired effect. Then after the walls are built other processes like painting or texturing can be then applied also automatically.

U.S. Pat. No. 9,120,229 of Roth, issued on Sep. 1, 2015, for Robot arm, discloses a robotic arm that features several consecutive mobile links and motors associated with axes relative to one another for the moving of the links. At least one of the links is selectively mountable in at least two configurations relative to its adjacent links.

This reference is deficient in that robotic arms are normally mounted stationary or with very restricted mobility, therefore limiting the amount of work that an arm would have because of its reach is limited to the size of the arm. In the construction of a structure ample and free robot mobility is needed in all ranges and long enough to reach and make a 3 story building segments.

U.S. Pat. No. 7,331,425 of Bukowski, issued on Feb. 19, 2008, for Lift machine, discloses a lift machine comprises a base, a support for supporting a load above the base, a lift actuator operatively connected between the base and the support for raising and lowering the support relative to the base, and a support stabilization mechanism operatively connected between the base and the support for stabilizing the support relative to the base during raising and lowering of the support by the lift actuator. The support stabilization mechanism comprises a pair of opposed linkages, with each of the pair of opposed linkages having a lower torque tube link and an upper torque tube link. The lower torque tube link has a torque tube operatively pivoted to the base. The upper torque tube link has a torque tube operatively pivoted to the support. The pair of opposed linkages are interconnected in such a manner that the pair moves in synchronization during raising and lowering of the support by the lift actuator and maintains the support substantially level even in the event that the center of mass of the load is offset from a vertical axis of the lift actuator.

This reference is deficient in that a lift machine is required to have mobility for this application, maneuverability is required in all directions and is also necessary for the lift to work autonomously, knowing when to perform the operations and movements needed and to coordinate with the robot arms as they work is imperative.

United States Patent Application 20100224427 of Nuchter, issued on Sep. 9, 2010 for OMNIDIRECTIONAL VEHICLE, DRIVING MODULE, AND MOBILE INDUSTRIAL ROBOT, discloses an omnidirectional vehicle has a driving module and a mobile industrial robot. The omnidirectional vehicle has omnidirectional wheels and a vehicle body, on which at least one of the omnidirectional wheels is mounted by means of an individual suspension.

This reference is deficient in that an omnidirectional vehicle has to have means to provide the extra height, the robotic arms would need in order to continue building as the structure rises. This reference is also deficient in that the movement of the machine cannot be controlled by remote or a human, so the motors which turn the wheels of the driving module have to be completely autonomous, know its position relative to the build area, know obstacles and coordinate within the process with other machines working around, with or near it.

United States Patent Application 20100224427, uses a type of omni-directional wheel similar to the one described in United States Patent Application 20030067209 of Marrero, issued on Apr. 10, 2003 for Omni-directional wheel and associated methods, discloses an omni-directional wheel for providing multi-directional movement is provided. The omni-directional wheel preferably includes a wheel hub formed of a plastic material, a plurality of pairs of spaced-apart wheel member mounting arms integrally formed of substantially the same plastic material as the wheel hub, and a plurality of separate and spaced-apart wheel members each formed of a plastic material including a wheel main body having a bulbous shape. Each of the plurality of wheel members are preferably connected between the wheel member mounting arms and within a respective one of the plurality of recesses so that each of the plurality of wheel members is adapted to operate independently of other ones of the plurality of wheel members and independently of the wheel hub.

This reference is deficient in that the vehicle would have to possess a form of way to change the center of gravity of the vehicle when working with the lift completely extended, even while the vehicle moves and especially when working on an incline. The robotic arms themselves can perform the work without any problem at almost any angle, but the platform is liable to tip, as the weight of the arms, the lift's center of gravity, the weight of the tools, the weight of the material and the inertia that the machine will have anytime the platform is moving, all these are factors that will have limitations for the use of this machine.

U.S. Pat. No. 8,926,240 of Zagar issued on Jan. 6, 2015 for End effector, discloses a quill style drilling/milling end effector with high tool positioning accuracy, a pressure foot with fast response in force and displacement feedback, and with automatic mounting and dismounting, normality sensing, and through the tool coolant delivery.

This reference is deficient in that the end effectors that the process requires, are utilized by the machine around the product being built from scratch, normally the product is able to be delivered to where the end effector is, and from there the robot can take over the handling of the tool. The problem in this case is that the end effector needs to be manipulated over a very large area, and operated even from within the structure itself while being built at any point of its production.

U.S. Pat. No. 5,123,831 of Enqvist Jun. 23, 1992 for Concrete extrusion machine, discloses an extrusion machine for making hollow elongated articles of concrete has an eccentric compaction disc that reciprocates and rotates to compact and release air from zero slump concrete. The machine avoids having to have a high frequency converter which is both expensive and noisy. At least one extruder screw is provided in the machine to feed concrete and form the elongated article. The screw has a die former at the outlet end to form a cavity in the elongated article. An eccentric compaction disc is positioned between the outlet end of the extruder screw and an input end of the die former, the input end of the die former is eccentric and coplanar with an eccentric disc face mounted for movement in a circular orbital path about the extruder screw axis. The output end of the die former is concentric with the extruder screw axis.

This reference is deficient in the same way as the milling end effector in that the end effector would have to be manipulated over a very large area to make a concrete structure big enough to be useable for the purpose of occupying people or things.

### SUMMARY OF THE INVENTION

The present invention relates to a machine which is able to 3d print and manufacture, using various types of materials such as, but not limited to: concrete, clay & paint. In order to make structures of any kind from dome houses to hangars, the designs fed to the printer could include furniture and decorations. It is fully automated, mobile and incorporates one or several multi-axis industrial robotic arms, as replacement for conventional fixed extruders found in Fused Deposition Modeling printers. The iterations presented here use an array of end effectors that the machine can utilize at different phases of construction, the iterations also use a plethora of sensors, to analyze, identify and perform solutions to logistics and coordinate within the process. The present invention has the ability to be mobile, meaning that it can transport itself from one print or build area to another, without the need to disassemble and reassemble the machine. The present invention is a perfect marriage between 3d printing technology, industrial robots and industrial automation for the purpose of building things.

The purpose of this invention is to provide a solution to construct affordable housing & structures, by automating in great part the work to be done, and therefore start replacing human labor out from the process. It is also the purpose of this invention, to reduce wasted materials and to speed up our construction and manufacturing practices.

Current advances in this technology, allows for the construction of a single machine to build just the walls of one small house in only less than 24 hours, already starting to render traditional construction methods completely obsolete.

It is therefore a primary object of the present invention, to provide a structure building machine which will eventually eliminate human labor from the process of construction, thus significantly enhancing the quality and speed of traditional construction and manufacturing methods.

It is another object of the present invention to provide a structure building machine which will significantly enhance the quality and speed of traditional construction and manufacturing methods at a very significant savings.

It is a further object of this invention to provide a structure building machine, which can easily be adapted to use with various types of terrain and construction areas, to increase the flexibility of application, and to reduce the amount of ground preparation for construction and for the machine.

It is still a further object of the present invention, to provide a structure building machine that could rise buildings and structures, much faster, cheaper, with higher quality, more safely and with little or no loss of time or disruption due to human factors.

It is still a further object of the present invention to provide a structure building machine, that is not only limited to the construction of walls, the present invention provides the means for the machine to carry around various things, such as doors and windows, and to have the ability of installing these items onto the structure being built.

It is still a further object of the present invention to provide a structure building machine, which can be so precise that if wanted to, it could deliver a material loaded with seeds for example, and deliver it with extreme accuracy only where it's intended. The machine could cover only the outer layers of the structure in order to give it an “Earth Home” look. This feature could be used by architects to design with the intention of providing a sustainable home for its residents, not limited to sustainability this feature could simply be used to provide an aesthetically pleasing façade, or to help save in energy consumption for cooling and heating, as the plants can provide a natural form of insulation.

It is still a further object of the present invention to provide a structure building machine, which can also create furniture, décor, furnishings, installation of piping, installation of electrical. Meaning that essentially by the time the machine leaves the print area, the printed home or structure is move-in-ready.

It is still a further object of the present invention to provide a structure building machine, which can not only deposit material, but it can also remove it, using various carving and sculpting methods. Programs like milling, cutting or any type of Computer Numerical Control work. Can be easily incorporated into the logistics, it's a simple matter of supplying the machine with the right tool, and supplying the means for the machine to choose the right tool at the right time, then the machine can then coordinate its movements to create a desired outcome.

These and other objects of the present invention, will become apparent to those skilled in this art upon reading the accompanying description, drawings, and claims set forth herein. The headings provided herein are for the convenience for the reader only.

No headings should be construed to limiting upon the content in any way.

### BRIEF DESCRIPTION OF THE DRAWINGS

FIG. 1 is a side view of the machine capable of building structures according to the present invention.

FIG. 2 is a side view of a second iteration for the 3d printer machine capable of building structures according to the present invention

FIG. 3 is a view of a third iteration for the 3d printer machine capable of building structures according to the present invention

FIG. 4 is a side view of the second iteration seen in FIG. 2 including some of the components that can be used to make the machine work as intended, such as pumps, compressors, electronics and electric components.

### DETAILED DESCRIPTION OF THE INVENTION

### 1. Definitions

Extrusion is a process used to create objects of a fixed cross-sectional profile. A material is pushed through a die of the desired cross-section.

In robotics, an end effector is the device at the end of a robotic arm, designed to interact with the environment. The exact nature of this device depends on the application of the robot.

### 2. Best Mode of the Invention

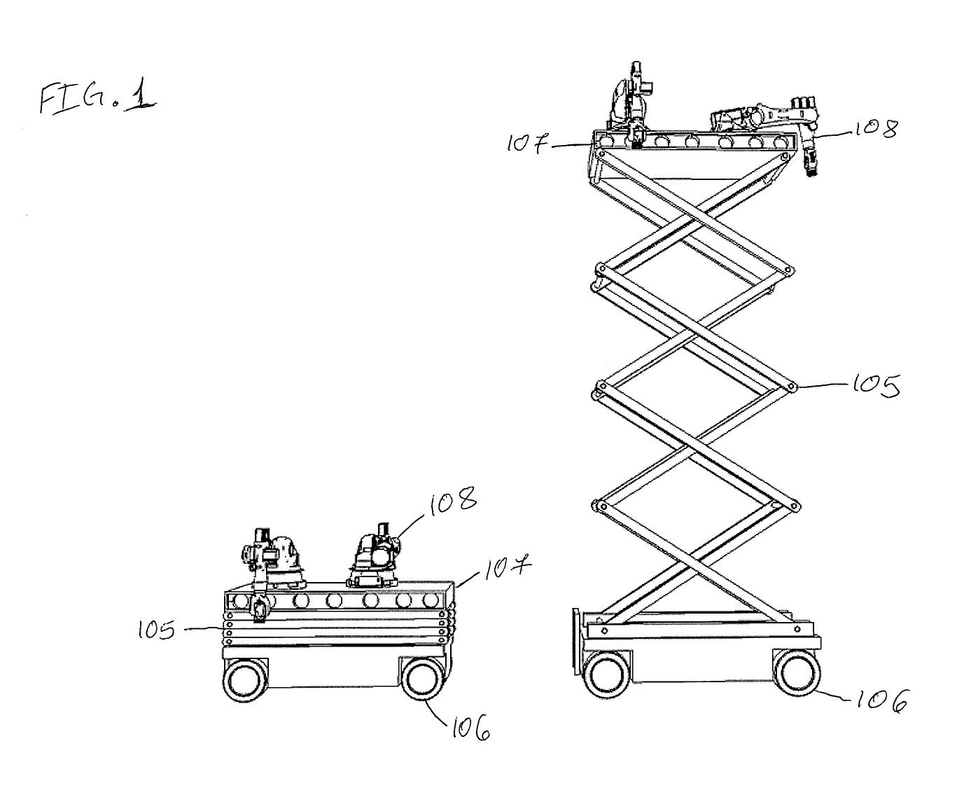

FIG. 1 shows a side view of the best mode contemplated by the inventor of the machine to build structures according to the concepts of the present invention. Its design incorporates omni-directional wheels (106) which will allow movement to the platform in any direction. Uses one or more robotic arms (108) as replacement for current conventional extruders to expand on the flexibility that the machine could possess, since essentially almost any tool could be incorporated to do a specific job now that we have an infinite and free range of movements, not limited to any space and giving us the opportunity to manufacture almost anything that a home or a structure needs to have, with a single machine. The platform is raised by a high accuracy hydraulic lift (105), strong enough to lift the arms and tools without problem, as the machine finishes its work at ground level, the lift (105) extends the height to the exact desired position, then it holds that position until the machine has finished its work, it then rises again just a as needed to keep on working on the next layer. The movements are repeated until it has built a finished wall of the desired height, the machine can use this lift (105) to position itself anywhere in the construction, to perform any given task even come in through the doors and work on the insides of the structure, not limited to just the pouring of the concrete or material being used. The machine can hold several different tools, these tools sit on a type of quick disconnect fixture (107) until the machine needs them. As soon as the machine deposits a tool in the fixture (107), the machine starts a clean in place process, pumping cleaning material through the lines and avoid maintenance issues.

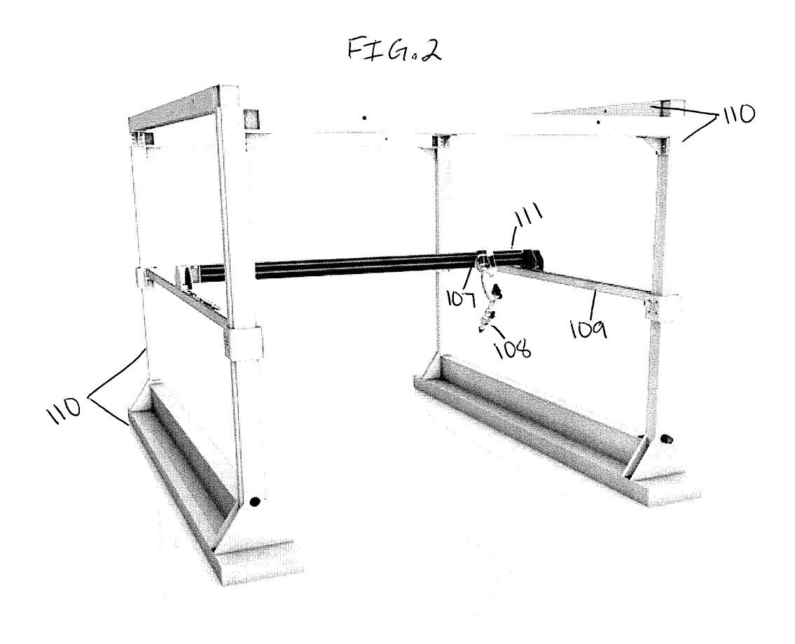

FIG. 2 shows another iteration that can be contemplated although it has limitations, unlike the iteration portrayed in FIG. 1 this model has the drawback that it's print area it's limited to the size of the frame (110) in which the robot arm (108) would move along its axis (111,110,107). So being able to give movement to these arm in a free range without limitations, increases the potential for the products that this machine can make tremendously. In this FIG. 2 the robots move along the tracks in axis X (107), along the beam on axis Y (111) and along the support beams for the Z axis (109)

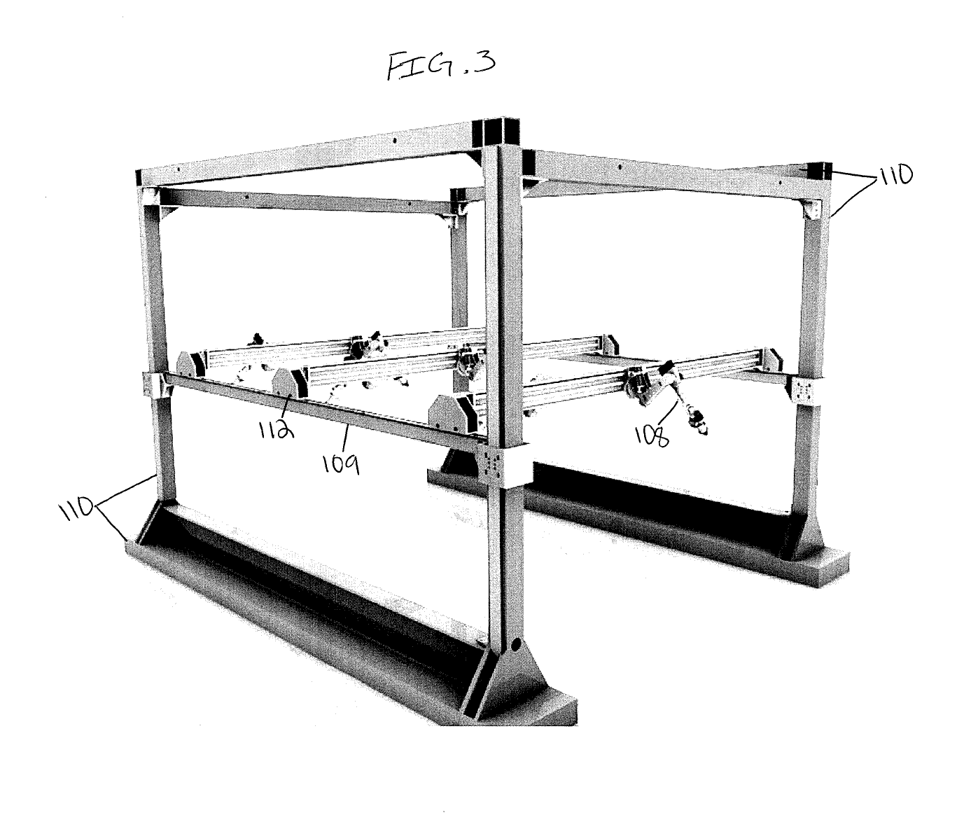

FIG. 3 shows yet another iteration that can be contemplated, it is similar in that it's comprised of: the frame (110), the robot arm (108), the X axis carriage (107), the Y axis carriage (111) and the Z axis carriage (109). The purpose of this model is to decrease printing times by increasing the amount of extruders in the form of robotic arms (108), and therefore increasing the amount of material that can be deposited at the same time, thus decreasing build times considerably.

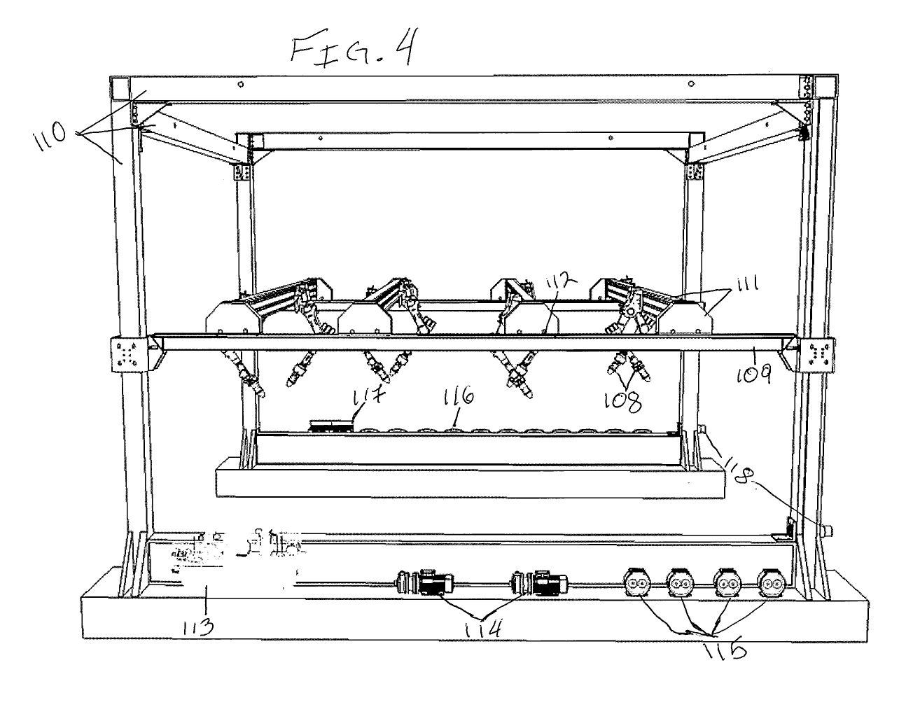

FIG. 4 Shows a model of the iteration shown in FIG. 3, in this figure some of the components that are needed to make the machine work as intended, such as: the compressors (113) will provide air pressure needed in order to operate the pneumatic devices like valves and solenoids, which will help control the flow of materials, or to help deliver a material like aerosols and spray able materials like paint for example; the centrifugal pumps (114) will deliver high pressured materials, these pumps are especially useful for the cleaning process performed when a robot arm has finished using an end effector; the peristaltic pumps (115) will help with the delivery of the materials themselves, these pumps are especially useful for the transfer of semi-solids like concrete; the energy source, in this model we see an array of battery packs (116) but a generator or the pre-existing electrical grid could be used instead; the electronics (117) these are used for data acquisition and output control, the electronics (117) performs the calculations needed in order to orchestrate the motor pulses, vitals, positioning, and examination of the process that the machine will perform to work properly and effectively.

### 3. How to Make the Invention

Robotic arms FIG. 1 (108) are mounted in a structure that allows linear movement to the arms, in X, Y and Z directions FIG. 1 (106). Placing the arms to the desired position, then the arms can further position themselves independently to start applying or removing material, as the material starts reaching a certain height, the structure will start lifting using the assisted lift mechanism FIG. 1 (105). Since the construction process requires different materials and procedures, the robot has the ability to quickly change tools and end effectors and adapt to the application accordingly FIG. 1 (107). The machine's mobility is aided by a plethora of sensors for the detection of movement, terrain, positioning and prevention of collisions.

Pumps shown in FIG. 4 (115) are used to deliver the materials needed at a particular point in the construction and valves (not shown) can be used to control and stop the flow of these materials, semi-solid pumps can be used to deliver materials such as concrete and high pressure pumps shown in FIG. 4 (114) could be used for the clean in place procedure, which is performed once the machine has finished using any material or tool.

Pneumatics FIG. 4 (113) are to be used to open and close solenoids, valves and to help deliver a material such as the act to pressurize spray able materials like paint.

Electronics FIG. 4 (117) are needed to control with high accuracy and to monitor every single process and vitals of the machine, for the measurement, delivery and tracking of the materials being used, such as flow sensors and electronically controlled pneumatic flow valves, as well as keeping track of the positioning relative to the print and other machines working around it.

Hydraulics FIG. 1 (105) are used to operate the assisted lift mechanism, it operates on high accuracy pistons, strong enough to carry and lift the robotic arms and the added load with no problems.

Essentially any end effector that is currently designed to be mounted on a robot, can be used by this machine and can be programed to perform a certain function on the construction practice, from pouring the concrete, to mounting the windows, installing doors and even carve intricate sculptures on the piece. And if the tool doesn't exist for a specific task, it can be designed.

### 4. How to Use the Invention

These machines work mostly autonomously, they are controlled via software, the process starts with the cutting of a computer aided design 3d rendering, the model is sliced, then those layers are sent as two dimensional patterns to the machine, to be translated as movements and real coordinates to follow. The machine then starts laying the material on the ground following these patterns, after repeating this action several times, we end up with a three dimensional object, in our case, could be a wall made of clay or concrete for example.

After the walls are built, the software keeps track of where the walls are located and the exact relative position of the machine, relative to objects made in the process, but also relative with objects in the way like obstacles, other machines or materials being handled and distributed for the purpose of constructing, then from there the machine knows where to apply the rest of the commands to complete the construction, like applying paint, smoothing out surfaces, carving moldings, installation of plumbing, making of the furniture, furnishings and so on.

The machine is positioned where desired, then it follows a pattern given by the software, applying or removing material as it moves, the assisted lift mechanism FIG. 1 (105) provides the extended height the arms would need in order to keep building once it has reached the maximum height that a robot would have, so as the wall continues to rise, the machine can still perform its work, doing any task given.

Materials are fed into the machine for its use when they are needed, although some material can be carried around by the machine like paints or other, but materials that are time sensitive like concrete, can be pumped directly into the extruder, so then the extruder can control the exact amount of material that it needs to deposit at the right rate, sensors control the flow and make sure that there are no air gaps or problems during the transport of the materials to the delivering nozzle, we also ensure that the product is contaminant free, to avoid damage to the unit and we ensure that the mixtures of materials are set to the right content. Automated pneumatic valves control the flow of the materials by preventing or limiting their pass, and they are used as a solution in order to integrate programs such as cleaning in place procedures.

The machine automatically cleans itself and the tool used. Agents to remove specific materials from the lines can be used at high pressure in order to clean them completely, and prevent damage or further maintenance to be required. This cleaning procedure requires the handling of chemicals, so industry standards should be used for the transport, handling, delivery and recycling or disposal of such.

Thus it will be appreciated by those skilled in the art that the present invention is not restricted to the particular preferred embodiments described with reference to the drawings, and that variations may be made therein without departing from the scope of the present invention as defined in the appended claims and equivalents thereof.

What is claimed is:

1. A machine capable of building structures, comprising: a way to manipulate the movement of a multi-axis extruder over a wide area, for the purpose of making things, such as: houses, dome shaped buildings, earth homes, multi-story homes and department complexes, hangars, buildings in general, fencing, sculptures, fountains, furniture, moldings, fixtures, doors, window frames, and a wide array of products that can be produced at normal to large scale with extrude-able materials like clay or concrete among many others.

2. The machine capable of building structures according to claim 1, wherein once the walls are completed, a smaller version of the machine described in claims 2 and 3, comprises a method to be able to come into the structure, even through the doors, meant to do work related to the process of construction on the insides of the same construction.

3. The machine capable of building structures according to claim 1, further comprises a method of incorporating 3d printing technology to start building from scratch, the machine automatically deposits a variety of specific materials, only when and where they must be used.

4. The machine capable of building structures according to claim 1, further comprises a method to 3d print with metal. Metal is needed for reinforcement and to be used to print support structure when it is needed, but it can also be used to create decorations or parts of pieces built with other materials.

5. The machine capable of building structures according to claim 1, further comprises a method to print with a material fertilized and impregnated with seeds, this feature can give the machine the possibility to create structures with added value to the end consumer, since plants can be used in the form of insulation, as a means of sustainability, in terms of food and to simply provide the means to design and build an “Earth Home” façade and décor.

6. The machine capable of building structures according to claim 1, further comprises a method to print with a semi-solid material, even fibrous materials such as Hemp Crete.

7. The machine capable of building structures according to claim 1, further comprises a method to control very detailed aspects of the material itself, such as moisture content or the specific contents of a mixture of materials, this is to ensure a high level of quality control of the end product, which in this case is anything that we are building at one given time with the machine, so the system integrates that flexibility of manufacturing many things with a single machine.

8. The machine capable of building structures according to claim 1, further comprises a method to handle and deliver spray able materials such as paints or coatings of any type.

9. The machine capable of building structures according to claim 1, further comprises a method to grab heavy objects like doors, windows to position them where desired with great accuracy, and install them using the tools supplied to the machine.

10. The machine capable of building structures according to claim 1, further comprises a method of using other experimental extrusion materials, like ceramics and precious metals.

11. The machine capable of building structures according to claim 1, further comprises a method of using other experimental extrusion materials, like sandstone.

12. The machine capable of building structures according to claim 1, further comprises a method of using other more common extrusion materials, like plastics.

13. The machine capable of building structures according to claim 1, further comprises a method to incorporate the use of anti-gravity materials, meaning that it can use materials that solidify instantly as they exit the extruder. These materials are used for example: In order to create support structure when dealing with sharp angles, like at a 90 degree intersections, where you would have a conventional rectangular door frame or window frame.

14. The machine capable of building structures according to claim 1, wherein the machine can continue to pour concrete at these intersections, to make a conventional door frame for example, gravity would take over the delivery of such material and it would fall to the ground, onto temporal rafts or support structures to provide the help required to overcome gravity while the main material solidifies and cures.

15. The machine capable of building structures according to claim 1, further comprises a method to perform CNC tasks, such as milling, cutting, and shaping using the tools according to the task being orchestrated.

16. The machine capable of building structures according to claim 1, further comprises a method to apply experimental materials such as conductive paint, by using conductive paints we could print the electrical system of a structure, right on the structure.

17. The machine capable of building structures according to claim 1, further comprises a method to easily incorporate emerging technologies and the use of new materials as it pertains, for example at the time of this writing, the use of glass in 3d printing is recently being developed.

18. A machine to build structures, comprising: robotic arms installed in movable aerial work platforms, such as a modified scissor lift equipped with Mecanum, caterpillar track, or omni-directional wheels, allowing the possibility to increase the print area to an unlimited size, whilst giving the mobility, rotational ability and height displacement, required to maneuver a large terrain, in any direction and to build from scratch, even inside a structure already printed, to build things from scratch or the machine can install finishing touches like doors and windows, running pipe lines and even making furniture.

19. The machine to build structures according to claim 18, wherein multiple machines to build structures are to be used to work on the same product, using sensors and motion planning to control important building processes and avoid mechanical collisions: data acquisition is analyzed in real time and processed in real time to give commands to the motors that control the arms and the wheels, as well as the lifts that raise the platform; and also to send signals to compressors, valves and pumps to control the flow and delivery of our materials.

20. The machine to build structures according to claim 18, further comprising a mechanical way to clean itself in place; lines carrying material are to be cleaned with high pressure pumps, using different cleaning materials such as: abrasive liquids and solvents in order to clean the product conveyor system and prevent damage or unnecessary maintenance; a flow of the materials can be controlled using flow sensor and pneumatic flow valves, as well as having an array of sensors to detect and feed information to the system in an automated way.

21. The machine to build structures according to claim 18, wherein the machine to build structures has such control of the manufacturing process that it even has the ability of depositing, and with great accuracy, a fertilized material impregnated with seeds, these seeds could be of any kind and can be used in order to grow a façade with living plants and organisms of choosing; such that the structure being built, has opportunity to grow a natural insulator from the elements, and to provide sustainability in terms of food and oxygen production, as well as reducing carbon footprint.

22. The machine to build structures according to claim 18, wherein the machine is able to quickly changing tools or end effectors, using quick disconnect technology, in order to perform different jobs or use different materials at different phases of construction.

23. The machine to build structures consists of robotic arms installed in movable aerial work platforms, such as a modified boom lift equipped with Mecanum, caterpillar track or omni-directional wheels, allowing the possibility of increasing the print area to an unlimited size, whilst giving the mobility, rotational ability and height displacement, required to maneuver a large terrain, in any direction and to build from scratch, even inside a structure already printed, to build things from scratch or to install things and finishing touches like doors and windows, running electrical and water pipe lines and even making furniture.

24. The machine to build structures according to claim 23, wherein multiple machines to build structures are to be used to work on the same product, using sensors and motion planning to control important building processes and avoid mechanical collisions: data acquisition is analyzed in real time and processed in real time to give commands to the motors that control the arms and the wheels, as well as the lifts that raise the platform; and also to send signals to compressors, valves and pumps to control the flow and delivery of our materials.

25. The machine to build structures according to claim 23, further comprising a mechanical way to clean itself in place; lines carrying material are to be cleaned with high pressure pumps, using different cleaning materials such as: abrasive liquids and solvents in order to clean the product conveyor system and prevent damage or unnecessary maintenance; a flow of the materials can be controlled using flow sensor and pneumatic flow valves, as well as having an array of sensors to detect and feed information to the system in an automated way.

26. The machine to build structures according to claim 23, wherein the machine to build structures has such control of the manufacturing process that it even has the ability of depositing, and with great accuracy, a fertilized material impregnated with seeds, these seeds could be of any kind and can be used in order to grow a façade with living plants and organisms of choosing; such that the structure being built, has opportunity to grow a natural insulator from the elements, and to provide sustainability in terms of food and oxygen production, as well as reducing carbon footprint.

27. The machine to build structures according to claim 23, wherein the machine is able to quickly changing tools or end effectors, using quick disconnect technology, in order to perform different jobs or use different materials at different phases of construction.
